(19) United States
(12) Patent Application Publication
(10) Pub. No.: US 2011/0018822 A1
(43) Pub. Date: Jan. 27, 2011

(54) GESTURE RECOGNITION METHOD AND TOUCH SYSTEM INCORPORATING THE SAME

(75) Inventors: Cho Yi LIN, Hsin-chu (TW); Yao Ching HSU, Hsin-chu (TW)

Correspondence Address: LOWE HAUPTMAN HAM & BERNER, LLP, 1700 DIAGONAL ROAD, SUITE 300, ALEXANDRIA, VA, 22314, US

(73) Assignee: PIXART IMAGING INC., Hsin-chu County (TW)

(21) Appl. No.: 12/775,838

(22) Filed: May 7, 2010

(30) Foreign Application Priority Data
Jul. 21, 2009 (TW) 098124545

(51) Int. Cl. G06F 3/041; G06F 3/01

(52) U.S. Cl. 345/173; 715/863

(57) ABSTRACT

A gesture recognition method for a touch system includes the steps of: capturing images looking across a plate surface with at least one image sensor; processing the images to determine a contact state variation of a single pointer on the plate surface; and recognizing whether a relative variation between the single pointer and the plate surface matches a predetermined gesture when the contact state variation is larger than a threshold. The present invention further provides a touch system.

### CROSS REFERENCE TO RELATED APPLICATION

This application claims the priority benefit of Taiwan Patent Application Serial Number 098124545, filed on Jul. 21, 2009, the full disclosure of which is incorporated herein by reference.

### BACKGROUND

1. Field of the Invention

This invention generally relates to a touch system and, more particularly, to a gesture recognition method and a touch system incorporating the same.

2. Description of the Related Art

Please refer to FIGS. 1a and 1b, they show operational schematic diagrams of a conventional touch system 9, which includes a touch plate 90 and at least two cameras 91 and 92. Field of views of the cameras 91 and 92 encompass the whole touch plate 90 for capturing images looking across a surface of the touch plate 90. When a user 8 contacts the touch plate 90 with one finger 81, the cameras 91 and 92 respectively capture image windows W₉₁ and W₉₂ containing a shadow I₈₁ associated with the tip of the finger 81. A processing unit calculates two dimensional coordinates of the finger 81 contacting the touch plate 90 according to one dimensional positions of the shadow I₈₁ associated with the tip of the finger 81. In this manner, the position and displacement of the finger 81 relative to the touch plate 90 can be obtained and the processing unit may accordingly control a display to execute corresponding operations according to the variation of the two dimensional coordinates of the finger 81.

When the user 8 contacts the touch plate 90 with two fingers 81 and 82 at the same time, image windows W₉₁′ and W₉₂′ respectively captured by the cameras 91 and 92 contain shadows I₈₁ and I₈₂ associated with the two fingers 81 and 82. The processing unit respectively calculates two dimensional coordinates of the two fingers 81 and 82 relative to the touch plate 90 according to one dimensional positions of the shadows I₈₁ and I₈₂ contained in the image windows W₉₁′ and W₉₂′ and recognizes the gesture according to a variation of the coordinates of the two fingers 81 and 82.

However, the operating method of the touch system 9 is to calculate two dimensional coordinates of a finger contacting the touch plate 90 according to one dimensional positions of the shadow associated with the finger tip in each image window, when a user touches the touch plate 90 with a plurality of fingers, e.g. fingers 81 and 82, the finger 82 will block the finger 81 with respect to the camera 92 as shown in FIG. 1b, the image window W₉₂′ captured by the camera 92 may not contain the shadows of all fingers. Accordingly, it is not possible to correctly calculate the two dimensional coordinates of every finger in some circumstances. Although this problem can be solved by installing additional cameras, the system cost will be increased at the same time.

Accordingly, the present invention further provides a gesture recognition method and a touch system incorporating the same so as to solve the problems existed in the above mentioned conventional touch system.

### SUMMARY

The present invention provides a gesture recognition method and a touch system incorporating the same that may perform mode switching according to a contact state variation of a single finger on a plate.

The present invention provides a gesture recognition method for a touch system including the steps of: capturing images looking across a plate surface with at least one image sensor; processing the images to determine a contact state variation of a single pointer on the plate surface; and recognizing whether a relative variation between the single pointer and the plate surface matches a predetermined gesture when the contact state variation is larger than a threshold.

The present invention further provides a gesture recognition method for a touch system including the steps of: capturing images looking across a plate surface with at least one image sensor; processing the images to detect a contact point of a single pointer on the plate surface; and recognizing whether a contact of the single pointer on the plate surface matches a predetermined gesture according to a state variation and a position change of the contact point.

The present invention further provides a touch system including a plate, at least one light source, at least one image sensor and a processing unit. The plate has a plate surface. The light source is disposed on the plate surface. The image sensor captures image windows, looking across the plate surface, containing a shadow of a single pointer blocking the light source. The processing unit recognizes whether a width variation or an area variation of the shadow in the image windows is larger than a threshold and recognizes whether a position change of the single pointer on the plate surface matches a predetermined gesture when the width variation or the area variation is larger than the threshold.

According to the gesture recognition method of the present invention and a touch system incorporating the same, in the first mode the touch system may control the motion of a cursor according to a coordinate variation (or a position change) of a pointer; in the second mode the touch system may update pictures presented on an image display according to the coordinate variation (or the position change) of the pointer, e.g. updating the pictures to present object select, screen scroll, object drag, object zoom in/out or object rotate, wherein the object may be an icon or a window.

Since the gesture recognition method of the present invention and a touch system incorporating the same may perform gesture recognition according to a single pointer, miscalculation of the coordinates of a plurality of pointers from blocking each other can then be avoided.

### BRIEF DESCRIPTION OF THE DRAWINGS

Other objects, advantages, and novel features of the present invention will become more apparent from the following detailed description when taken in conjunction with the accompanying drawings.

FIG. 1a shows an operational schematic diagram of a conventional touch system.

FIG. 1b shows another operational schematic diagram of the touch system shown in FIG. 1a.

FIG. 2a shows a block diagram of the touch system in accordance with an embodiment of the present invention.

FIG. 2b shows a schematic diagram of a partial field of view of the image sensor shown in FIG. 2a and an image window captured thereby.

FIG. 3 shows an upper view of the touch system according to the first embodiment of the present invention.

FIG. 4a shows an operational schematic diagram of the touch system according to the first embodiment of the present invention.

FIG. 4b shows a schematic diagram of an image window captured by the image sensor shown in FIG. 4a.

FIG. 5a shows a block diagram of the touch system according to the second embodiment of the present invention.

FIG. 5b shows a schematic diagram of image windows respectively captured by the two image sensors shown in FIG. 5a.

FIG. 6a-6c show operational schematic diagrams of the first mode of the touch system according to the embodiments of the present invention.

FIG. 7a-7c show operational schematic diagrams of the second mode of the touch system according to the embodiments of the present invention.

FIG. 8a-8c show schematic diagrams of different gestures corresponding to the touch system according to the embodiments of the present invention.

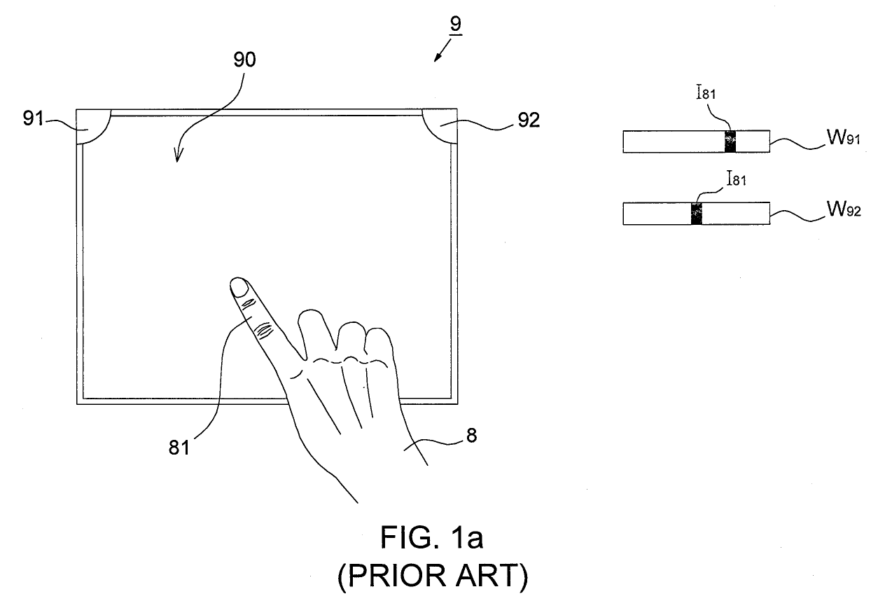

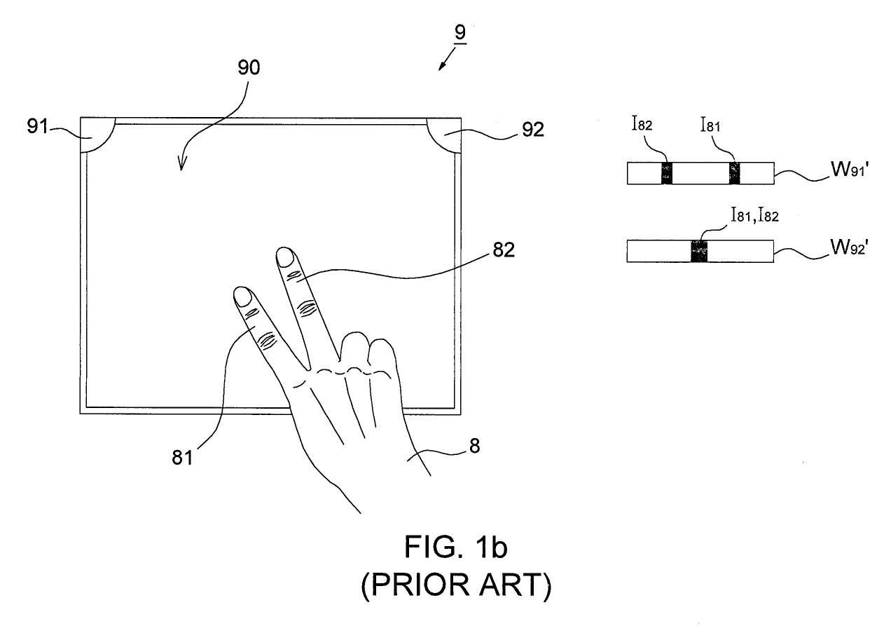

### DETAILED DESCRIPTION OF THE EMBODIMENT

It should be noticed that, wherever possible, the same reference numbers will be used throughout the drawings to refer to the same or like parts.

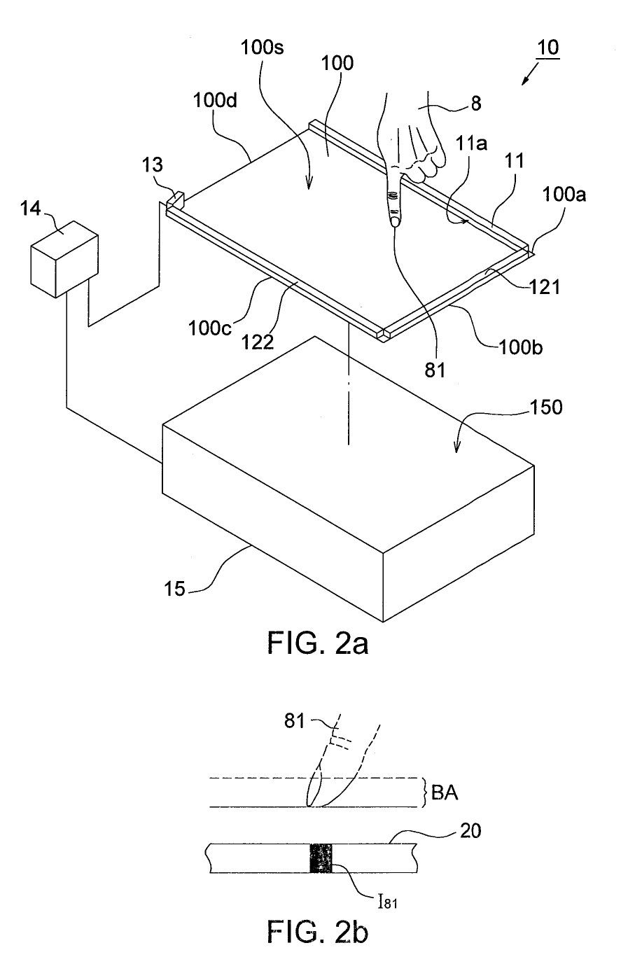

Please refer to FIGS. 2a and 2b, FIG. 2a shows a block diagram of the touch system 10 in accordance with an embodiment of the present invention, and FIG. 2b shows a schematic diagram of a partial field of view of the image sensor 13 and an image window 20 captured by the image sensor 13 shown in FIG. 2a. The touch system 10 includes a plate 100, an illumination unit 11, a first light source 121, a second light source 122, an image sensor 13, a processing unit 14 and an image display 15.

The plate 100 includes a first side 100a, a second side 100b, a third side 100c, a fourth side 100a and a plate surface 100s. Embodiments of the plate 100 include a white board and a touch screen. The plate surface 100s is served as the input area of the touch system 10.

In this embodiment, the illumination unit 11 is disposed at the first side 100a on the plate surface 100s. The illumination unit 11 may be an active light source or a passive light source. When the illumination unit 11 is an active light source, it is preferably a linear light source. When the illumination unit 11 is a passive light source, it is configured to reflect the light from other light sources, e.g. the first light source 121 and second light source 122, and the illumination unit 11 further includes a reflecting surface 11a facing the third side 100c of the plate 100, wherein the reflecting surface 11a may be made of proper materials. The first light source 121 is disposed at the second side 100b on the plate surface 100s and preferably illuminates toward the fourth side 100d of the plate 100. The second light source 100s is disposed at the third side 100c on the plate surface 100s and preferably illuminates toward the first side 100a of the plate 100, wherein the first light source 121 and the second light source 122 are preferably active light sources, for example, but not limited to, linear light sources.

The image sensor 13 is preferably disposed at one corner of the plate 100, for example at the corner intersected by the second light source 122 and the fourth side 100d of the plate 100 in this embodiment, and the illumination unit 11 is disposed at a side, which is not adjacent to the image sensor 13, on the plate surface 100s. The image sensor 13 captures images looking across the plate surface 100s and encompassing a space defined by the illumination unit 11, first light source 121, second light source 122 and fourth side 100d of the plate 100. When a pointer, e.g. a finger 81, contacts the plate surface 100s, a field of view of the image sensor 13 will exist the tip of the finger 81 as shown in the upper part of FIG. 2b, wherein “BA” refers to a high intensity area and a height thereof is generally determined by the size of the illumination unit 11 and light sources 121, 122. Therefore, the image sensor 13 may successively capture image windows 20 containing a shadow I₈₁ that is formed by the tip of finger 81 blocking the illumination unit 11 or the light source 121 as shown in the lower part of FIG. 2b. Embodiments of the image sensor 13 include, but not limited to, a CCD image sensor and a COMS image sensor. It is appreciated that the pointer may be replaced by other proper object and it is not limited to a finger.

The processing unit 14 is coupled to the image sensor 13 and configured to process the images captured by the image sensor 13 so as to recognize a width variation or an area variation of a shadow associated with a finger to accordingly control the touch system 10 to operate in a first mode or a second mode. When the processing unit 14 recognizes that a pointer contacts the plate surface 100s, it activates the touch system 10 to operate in a first mode; at this moment, the processing unit 14 calculates a two dimensional coordinate of the pointer contacting the plate surface 100s according to the position of the shadow associated with the pointer in the image window 20, and controls the motion of a cursor shown on the image display 15 according to a variation of the two dimensional coordinates obtained from successive image windows; wherein the two dimensional coordinates of the plate surface 100s may correspond to the position coordinates of a display screen 150 of the image display 15.

When the processing unit 14 recognizes the width variation or the area variation, which may become larger or smaller, of shadow associated with the pointer exceeds a threshold, it controls the touch system 10 to operate in a second mode; at this moment, the processing unit 14 calculates a two dimensional coordinate of the pointer contacting the plate surface 100s according to the position of the shadow associated with the pointer in the image window 20, performs gesture recognition according to a variation of the two dimensional coordinates between successive image windows, and controls the update of pictures presented on an image display 15 according to the recognized gesture, e.g. controlling the image display to present object select, screen scroll, object drag, object zoom in/out or object rotate, and details thereof will be illustrated hereinafter. In addition in the present invention, the sensitivity of switching between the first mode and second mode may be adjusted by dynamically adjusting the threshold; wherein a larger threshold corresponds to a lower sensitivity whereas a lower threshold corresponds to a higher sensitivity.

In FIG. 2a, to clearly show the touch system 10 of the present invention, the plate 100 is separated from the image display 15 but it is not a limitation of the present invention. In another embodiment, the plate 100 may be integrated on the screen 150 of the image display 15. In addition, when the plate 100 is a touch screen, the screen 150 of the image display 15 may also be served as the plate 100, and the illumination unit 11, the first light source 121, the second light source 122 and the image sensor 13 are disposed on the surface of the screen 150.

It is appreciated that although the plate 100 is shown as a rectangle and the illumination unit 11, the first light source 121 and the second light source 122 are perpendicularly disposed at three sides on the plate 100 in FIG. 2a, they are only exemplary and not a limitation of the present invention. In another embodiment, the plate 100 may be formed in other shapes; the illumination unit 11, the first light source 121, the second light source 122 and the image sensor 13 may be disposed in other spatial relationships on the plate surface 100s.

### First Embodiment

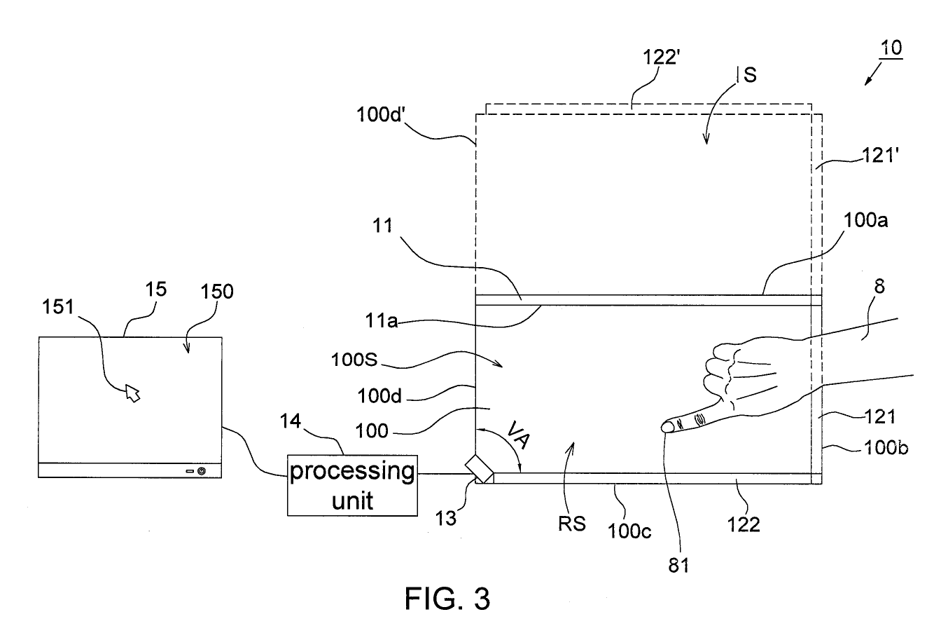

Please refer to FIG. 3, it shows an upper view of the touch system 10 according to the first embodiment of the present invention. In this embodiment, the illumination unit 11 is a passive light source (e.g. a reflecting component) and has a reflecting surface 11a facing the third side 100c of the plate 100. Accordingly, the first light source 121 may map a second mirror image 121′ relative to the reflecting surface 11a; the second light source 122 may map a third mirror image 122′ relative to the reflecting surface 11a; and the fourth side 100d of the plate 100 may map a fourth mirror image 100d′ relative to the reflecting surface 11a, wherein the illumination unit 11, the first light source 121, the second light source 122 and the fourth side 100d of the plate 100 together define a real space RS; and the illumination unit 11, the second mirror image 121′, the third mirror image 122′ and the fourth mirror image 100d′ together define a virtual space IS.

The image sensor 13 is disposed at the corner intersected by the second light source 122 and the fourth side 100d of the plate 100. A field of view VA of the image sensor 13 is looking across the plate surface 100s and encompasses the real space RS and the virtual space IS, and the image sensor 13 is configured to capture image windows containing a shadow associated with a pointer, e.g. a finger 81, inside the real space RS, wherein the shadow is formed by the pointer blocking the light source 121 and the illumination unit 11. In an embodiment, the image sensor 13 further includes a lens (or lens set) for adjusting the field of view VA of the image sensor 13 to allow the image sensor 13 to be able to capture a complete image encompassing the real space RS and the virtual space IS.

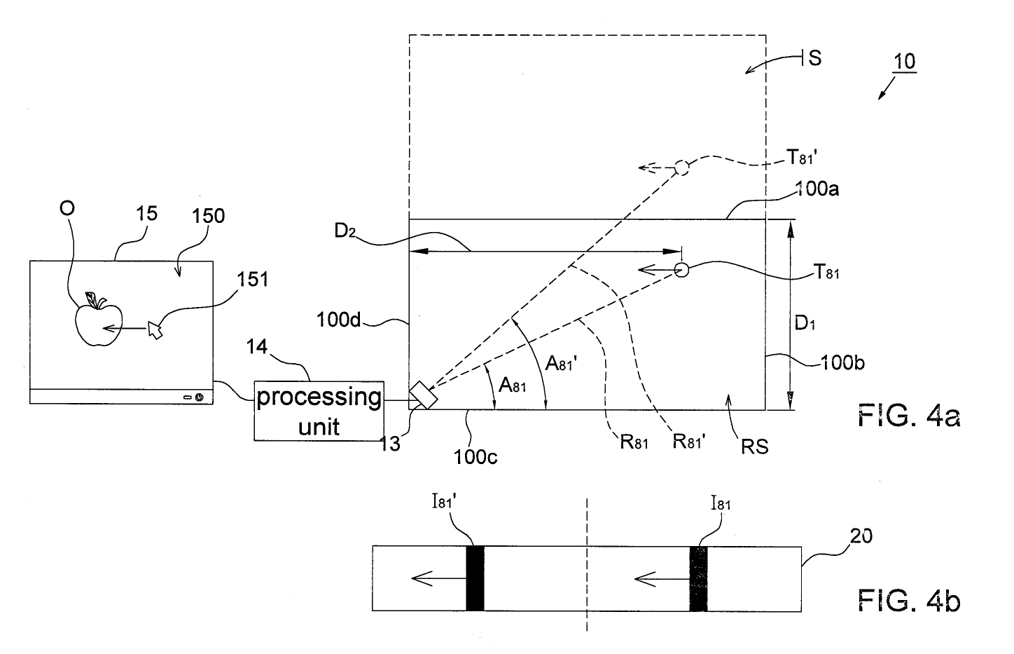

Please refer to FIGS. 4a and 4b, FIG. 4a shows an operational schematic diagram of the touch system 10 according to the first embodiment of the present invention and FIG. 4b shows a schematic diagram of an image window 20 captured by the image sensor 13 shown in FIG. 4a. As shown in FIG. 4a, when a pointer, e.g. a finger 81, contacts the plate surface 100s inside the real space RS, which is shown by a contact point T₈₁, the pointer maps a first mirror image in the virtual space IS, shown by a contact point T₈₁′ herein, relative to the reflecting surface 11a of the illumination unit 11 (i.e. a reflecting component in this embodiment). The image sensor 13 captures an image of the tip of the pointer through the first sensing route R₈₁ such that a shadow I₈₁ will exist in the image window 20; it also captures an image of the first mirror image through the second sensing route R₈₁′ such that a shadow I₈₁′ will exist in the image window 20 as shown in FIG. 4b. In this embodiment, relative relationships between a one dimensional position of a shadow in the image window 20 and an angle between a sensing route and the third side 100c of the plate 100 are pre-stored in the processing unit 14. In this manner, when the image sensor 13 captures images of the pointer and the first mirror image thereof to generate the image window 20, the processing unit 14 may respectively obtain a first angle A₈₁ and a second angle A₈₁′ according to one dimensional positions of the shadows I₈₁, I₈₁′ in the image window 20. Next, by using triangulation, the processing unit 14 may obtain a two dimensional coordinate of the contact point T₈₁ that the pointer contacts with the plate surface 100s.

For example in an aspect, the plate surface 100s forms a Cartesian coordinate system, wherein the third side 100c is served as an X-axis, the fourth side is served as a Y-axis and a location of the image sensor 13 is served as an original point of the Cartesian coordinate system. Therefore, the coordinate of a contact point T₈₁ in the Cartesian coordinate system may be represented as (a distance to the fourth side 100d, a distance to the third side 100c). In addition, the distance D₁ between the first side 100a and the third side 100c of the plate 100 may be pre-stored in the processing unit 14. In this manner, the processing unit 14 may obtain the two dimensional coordinate of the contact point T₈₁ of the pointer 81 according to the following steps: (a) the processing unit 14 calculates a first angle A₈₁ between the first sensing route R₈₁ and the third side 100c of the plate 100, and a second angle A₈₁′ between the second sensing route R₈₂ and the third side 100c of the plate 100; (b) the processing unit 14 calculates a distance D₂ between the contact point T₈₁ of the pointer 81 and the fourth side 100d of the plate 100 according to the equation D₂=2D₁/(tan A₈₁+tan A₈₁′); (c) the processing unit 14 calculates a y-coordinate of the contact point T₈₁ according to the equation D₂×tan A₈₁. Therefore, a two dimensional coordinate of the contact point T₈₁ may be represented as (D₂, D₂×tan A₈₁).

### Second Embodiment

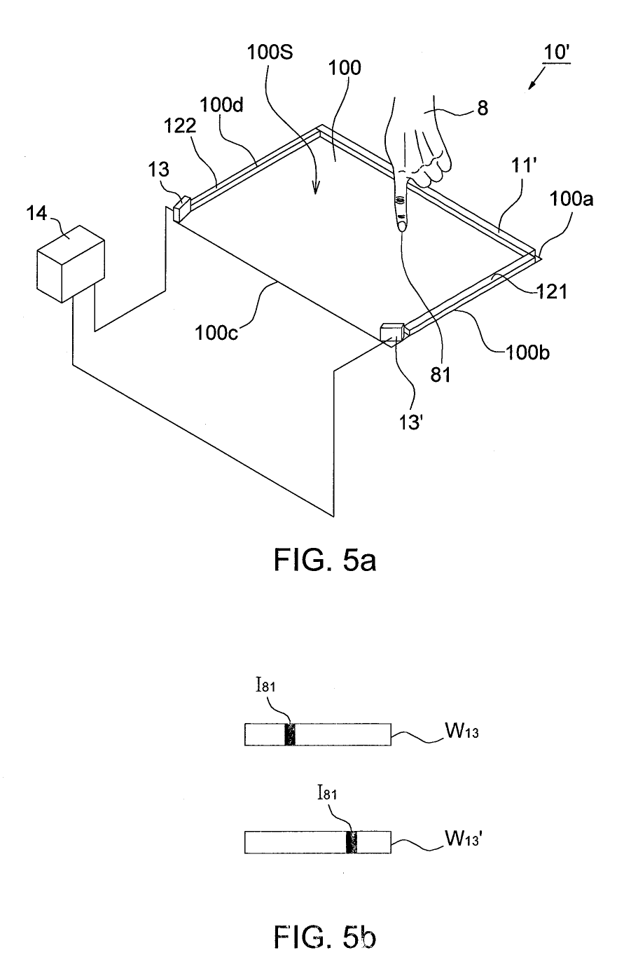

Please refer to FIGS. 5a and 5b, FIG. 5a shows a block diagram of the touch system 10′ according to the second embodiment of the present invention; FIG. 5b shows a schematic diagram of image windows captured by the two image sensors 13, 13′ shown in FIG. 5a. The differences between this embodiment and the first embodiment are in that the illumination unit 11′ herein is an active light source and the touch system 10′ includes two image sensors 13 and 13′.

In the second embodiment, the touch system 10′ includes a plate 100, an illumination unit 11′, a first light source 121, a second light source 122, two image sensors 13, 13′ and a processing unit 14. The illumination unit 11′ is disposed at the first side 100a on the plate surface 100s and preferably illuminates toward the third side 100c of the plate 100. The first light source 121 is disposed at the second side 100b on the plate surface 100s and preferably illuminates toward the fourth side 100d of the plate 100. The second light source 122 is disposed at the fourth side 100d on the plate surface 100s and preferably illuminates toward the second side 100b of the plate 100. The image sensor 13 is disposed at the intersection of the third side 100c and the fourth side 100d of the plate 100 and the field of view thereof is looking across the plate surface 100s. The image sensor 13′ is disposed at the intersection of the second side 100b and the third side 100c of the plate 100 and the field of view thereof is looking across the plate surface 100s. When a pointer, e.g. a finger 81, contacts with the plate surface 100s, the image sensor 13 captures an image window W₁₃ containing a shadow I₈₁ associated with the tip of finger 81 and the image sensor 13′ captures an image window I₈₁′ containing a shadow I₈₁′ associated with the tip of the finger 81. It is appreciated that the touch system 10′ may also include an image display (not shown) coupled to the processing unit 14.

The processing unit 14 is coupled to the image sensors 13 and 13′ for processing images captured by the image sensors 13 and 13′ to recognize a width variation or an area variation of the shadows I₈₁, I₈₁′ associated with a pointer so as to accordingly control the touch system 10′ to operate in a first mode or a second mode. When the processing unit 14 recognizes that a pointer contacts with the plate surface 100s, it activates the touch system 10′ to operate in the first mode; at this moment, the processing unit 14 calculates a two dimensional coordinate of the pointer contacting the plate surface 100s according to the positions of the shadows I₈₁, I₈₁′ associated with the pointer in the image windows W₁₃ and W₁₃′, and controls the motion of a cursor shown on an image display according to a variation of the two dimensional coordinates obtained from successive image windows W₁₃ and W₁₃′. When the processing unit 14 recognizes that the width variation or the area variation of the shadows I₈₁, I₈₁′ associated with the pointer exceeds a threshold, it controls the touch system 10′ to operate in a second mode; at this moment, the processing unit 14 calculates a two dimensional coordinate of the pointer contacting the plate surface 100s according to positions of the shadows associated with the pointer in the image windows W₁₃ and W₁₃′, performs gesture recognition according to a variation of the two dimensional coordinates obtained from successive image windows W₁₃ and W₁₃′, and controls the update of pictures presented on an image display according to the recognized gesture, e.g. controlling the image display to present object select, screen scroll, object zoom in/out, object drag or object rotate. The calculation of the two dimensional coordinates may also be performed through triangulation and details of the calculation is similar to that illustrated in first embodiment and thus will not be repeated again.

Details of the operating method of the touch system according to the embodiments of the present invention will be illustrated hereinafter. It should be noted that the gesture recognition method described below may be adapted to the touch systems 10 and 10′ in the first embodiment and the second embodiment.

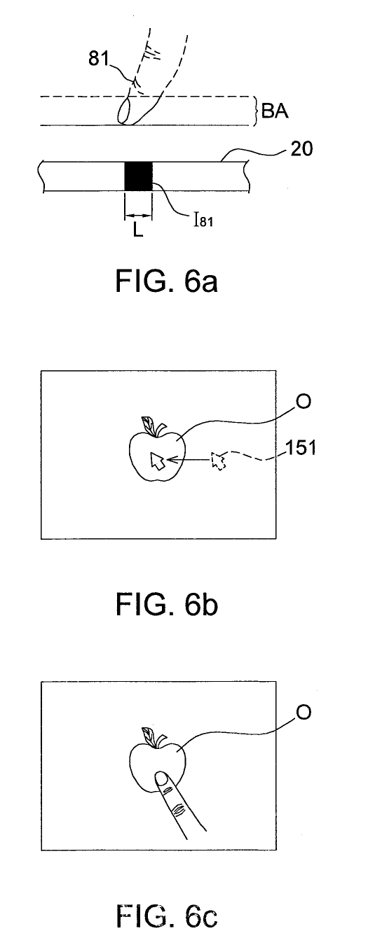

Please refer to FIGS. 2a and 6a-6c, when a user contacts the plate surface 100s with a pointer, e.g. a finger 81, the image sensor 13 captures the shadow I₈₁ associated with the tip of finger 81 to generate an image window 20, wherein a width of the shadow I₈₁ in the image window 20 is assumed to be L. After the processing unit 14 recognizes a contact event, it activates the touch system 10 and controls the touch system 10 to enter a first mode. In the first mode, the processing unit 14 calculates two dimensional coordinates of the finger 81 contacting the plate surface 100s according to the position of the shadow I₈₁ in the image window 20, and controls the motion of a cursor shown on the image display 15 according to a variation of the two dimensional coordinates as shown in FIG. 6b.

When the plate 100 is a touch screen, the user may directly contact a position upon an object O with his/her finger so as to activate the touch system 10 as shown in FIG. 6c. The processing unit 14 also calculates a two dimensional coordinate of the finger 81 relative to the plate surface 100s according to the position of the shadow I₈₁ in the image window 20.

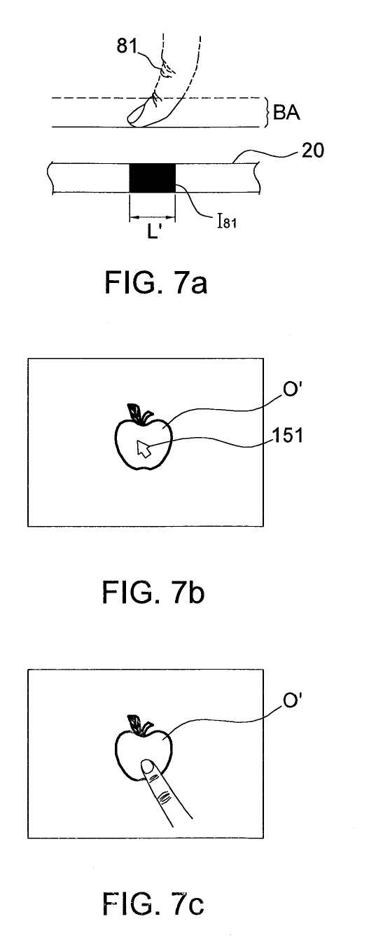

Please refer to FIGS. 2a and 7a-7c, when the user changes a contact state, e.g. a contact area, of the finger 81 on the plate surface 100s, the width and the area of the shadow I₈₁ in the image window 20 are also changed. For example in FIG. 7a, the width of the shadow I₈₁ in the image window 20 captured by the image sensor 13 is changed to L′. When the processing unit 14 recognizes that the width variation of the shadow exceeds a threshold, e.g. L′/L or |L′-L| exceeds a predetermined threshold, it controls the touch system 10 to enter a second mode. Similarly, the area variation of the shadow may be obtained according to the absolute value of a difference or the percentage of the contact areas of two contact states. That is, the threshold may be a variation percentage or a variation of the width or the area of the shadow associated with the pointer.

In the second mode, the processing unit 14 also calculates a two dimensional coordinate of the finger 81 relative to the plate surface 100s according to a position of the shadow I₈₁ in the image window 20, and then compares a variation of the two dimensional coordinates with gesture data pre-stored in the processing unit 14 to perform gesture recognition. That is, in the second mode the coordinate variation obtained by the processing unit 14 is not used to control the motion of the cursor 151, it is used to recognize the gesture of a user performed so as to execute predetermined operations, e.g. object select, screen scroll, object drag, object zoom in/out and object rotate, but the present invention is not limited to these operations. In the present invention, the object mentioned herein may be an icon or a window.

In the present invention, if it is desired to switch the touch system 10 between the first mode and the second mode, a user may change the width or the area of the shadow I₈₁ for a predetermined period of time, for example, but not limited to, one second, wherein during mode switching the finger 81 may be steady or is moving on the plate surface 100s.

Please refer to FIGS. 6a-8c, relationships between gestures performed by a user and operation functions will be illustrated hereinafter. It should be understood that the relationships between gestures and operation functions described below are exemplary and not the limitation of the present invention.

### Object Select

When the plate 100 is a white board, a user firstly contacts the plate surface 100s with a pointer to activate the touch system 10 and controls the touch system 10 to enter a first mode. Then, the user controls a cursor 151 to upon an object O to be selected by changing a relative position of the finger on the plate surface 100s as shown in FIG. 6b. Next, the user changes a contact state of the finger 81 on the plate surface 100s, as shown in FIG. 7a, so as to control the touch system 10 to enter a second mode. At this moment, the object may be shown with characteristic change as shown in FIG. 7b, e.g. color change or line width change, representing the object is selected.

When the plate 100 is a touch screen, the user contacts the plate surface 100s upon the object O to activate the touch system 10 as shown in FIG. 6c. Then, the user changes a contact state of the finger 81 on the plate surface 100s so as to have the touch system 10 enter a second mode to select the object O′ as shown in FIG. 7c.

### Screen Scroll

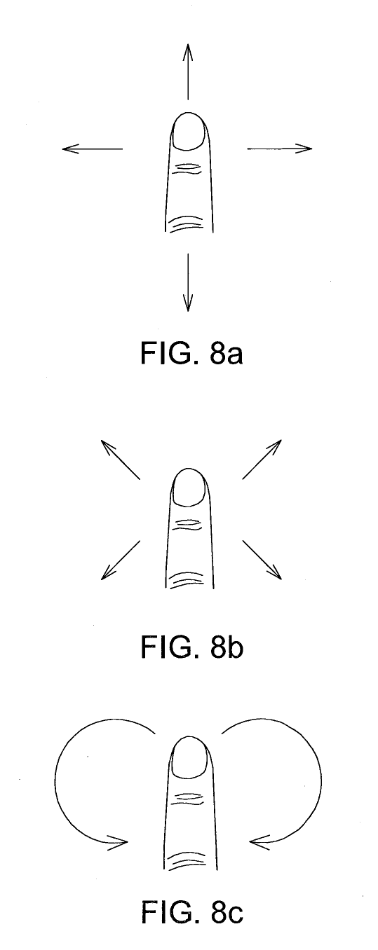

A user first contacts the plate surface 100s with his/her finger to activate the touch system 10 and to control the touch system 10 to enter a first mode as shown in FIG. 6a or 7a. Then, the user changes a contact state of the finger 81 on the plate surface 100s, e.g. from the state shown in FIG. 6a to FIG. 7a or from the state shown in FIG. 7a to FIG. 6a, for a predetermined period of time to have the touch system 10 enter a second mode. Next, when the processing unit 14 detects the finger 81 to move upward, downward, leftward or rightward with respect to the plate surface 100s as shown in FIG. 8a, it recognizes that the user is performing a scroll gesture. The processing unit 14 then controls the image display 15 to update its screen 150 to present corresponding pictures.

### Object Drag

A user first contacts the plate surface 100s with his/her finger 81 to activate the touch system 10 and to control the touch system 10 to enter a first mode. Then the user controls a cursor 151 to upon an object O to be selected by changing the relative position of the finger 81 and the plate surface 100s. Next, the user changes a contact state of the finger 81 on the plate surface 100s so as to enter a second mode, and at this moment the object O′ may be shown to be selected. Next, when the processing unit 14 detects the finger 81 to move upward, downward, leftward or rightward with respect to the plate surface 100s as shown in FIG. 8a, it recognizes that the user is performing a drag gesture. The processing unit 14 then controls the image display 15 to update its screen 150 to present corresponding pictures.

### Object Zoom

A user first contacts the plate surface 100s with his/her finger 81 to activate the touch system 10 and to control the touch system 10 to enter a first mode. Then the user controls a cursor 151 to upon an object O to be selected by changing the relative position of the finger 81 and the plate surface 100s. Next, the user changes a contact state of the finger 81 on the plate surface 100s so as to enter a second mode, and at this moment the object O′ may be shown to be selected. Next, when the processing unit 14 detects the finger 81 to move diagonally with respect to the plate surface 100s as shown in FIG. 8b, it recognizes that the user is performing a zoom gesture (zoom in or zoom out). The processing unit 14 then controls the image display 15 to update its screen 150 to present corresponding pictures.

### Object Rotate

A user first contacts the plate surface 100s with his/her finger 81 to activate the touch system 10 and to control the touch system 10 to enter a first mode. Then the user controls a cursor 151 to upon an object O to be selected by changing the relative position of the finger 81 and the plate surface 100s. Next, the user changes a contact state of the finger 81 and the plate surface 100s so as to enter a second mode, and at this moment the object O′ may be shown to be selected. Next, when the processing unit 14 detects the finger 81 to rotate with respect to the plate surface 100s as shown in FIG. 8c, it recognizes that the user is performing a rotate gesture. The processing unit 14 then controls the image display 15 to update its screen 150 to present corresponding pictures.

As mentioned above, a conventional touch system may not be able to correctly calculate the coordinates of contact points of a plurality of pointers that block each other. The present invention further provides a touch system that may perform two operation modes by using a single pointer (FIGS. 2a, 3 and 5a). The present invention may switch between two operation modes simply by changing a contact state of a pointer on the plate surface and the touch system of the present invention has lower system cost.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A gesture recognition method for a touch system, comprising the steps of:
capturing images looking across a plate surface with at least one image sensor;
processing the images to determine a contact state variation of a single pointer on the plate surface; and
recognizing whether a relative variation between the single pointer and the plate surface matches a predetermined gesture when the contact state variation is larger than a threshold.

2. The gesture recognition method as claimed in claim 1, wherein the contact state variation is determined according to a width variation or an area variation of a shadow associated with the single pointer in the images.

3. The gesture recognition method as claimed in claim 1, wherein when the contact state variation is larger than the threshold maintaining for a predetermined period of time, the process of recognizing whether a relative variation between the single pointer and the plate surface matches a predetermined gesture is performed.

4. The gesture recognition method as claimed in claim 1, wherein the predetermined gesture is a scroll gesture, a drag gesture, a zoom gesture or a rotate gesture.

5. The gesture recognition method as claimed in claim 1, further comprising the step of: activating the touch system when a contact between the single pointer and the plate surface is detected according to the images captured.

6. The gesture recognition method as claimed in claim 1, further comprising the step of: controlling the motion of a cursor shown on an image display according to the relative variation between the single pointer and the plate surface when the contact state variation is smaller than the threshold.

7. The gesture recognition method as claimed in claim 6, wherein the touch system is in a first mode when the contact state variation is larger than the threshold whereas the touch system is in a second mode when the contact state variation is smaller than the threshold, and the gesture recognition method further comprises the step of: dynamically adjusting the threshold thereby adjusting the sensitivity of mode switching.

8. A gesture recognition method for a touch system, comprising the steps of:
capturing images looking across a plate surface with at least one image sensor;
processing the images to detect a contact point of a single pointer on the plate surface; and
recognizing whether a contact of the single pointer on the plate surface matches a predetermined gesture according to a state variation and a position change of the contact point.

9. The gesture recognition method as claimed in claim 8, further comprising the step of: calculating the position change of the contact point according to a position of a shadow associated with the single pointer in the images.

10. The gesture recognition method as claimed in claim 8, wherein the state variation is determined according to a width variation or an area variation of a shadow associated with the single pointer in the images.

11. The gesture recognition method as claimed in claim 10, wherein when the width variation or the area variation of the shadow is larger than a threshold, the process of recognizing whether the contact of the single pointer on the plate surface matches a predetermined gesture according to a position change of the contact point is performed.

12. The gesture recognition method as claimed in claim 8, wherein the predetermined gesture is a scroll gesture, a drag gesture, a zoom gesture or a rotate gesture.

13. The gesture recognition method as claimed in claim 8, further comprising: updating pictures shown on an image display according to the gesture recognized.

14. A touch system, comprising:
a plate, having a plate surface;
at least one light source, disposed on the plate surface;
at least one image sensor, capturing image windows, looking across the plate surface, containing a shadow of a single pointer blocking the light source; and
a processing unit, recognizing whether a width variation or an area variation of the shadow in the image windows is larger than a threshold and recognizing whether a position change of the single pointer on the plate surface matches a predetermined gesture when the width variation or the area variation is larger than the threshold.

15. The touch system as claimed in claim 14, wherein the plate is a white board or a touch screen.

16. The touch system as claimed in claim 14, wherein the image sensor is disposed at a corner of the intersection of two sides of the plate surface, and the touch system further comprises a reflecting component disposed at a side not adjacent to the image sensor on the plate surface.

17. The touch system as claimed in claim 16, wherein the image sensor captures image windows containing two shadows of the single pointer blocking the light source and the reflecting component, and the processing unit calculates the position change of the single pointer on the plate surface according to positions of the two shadows in the image windows.

18. The touch system as claimed in claim 14, wherein the touch system comprises two image sensors respectively capturing image windows containing a shadow of the single pointer blocking the light source, and the processing unit calculates the position change of the single pointer on the plate surface according to positions of the shadows in the image windows.

19. The touch system as claimed in claim 14, further comprising an image display coupled to the processing unit, wherein the processing unit controls the image display to update pictures presented thereon while recognizing the position change of the single pointer on the plate surface matches a predetermined gesture.

20. The touch system as claimed in claim 14, wherein the predetermined gesture is a scroll gesture, a drag gesture, a zoom gesture or a rotate gesture.
